(19) United States
(12) Patent Application Publication
(10) Pub. No.: US 2025/0148137 A1
(43) Pub. Date: May 8, 2025

(54) METHOD AND SYSTEM OF EDITING AN ENGINEERING DESIGN (CAD MODEL)

(71) Applicant: Siemens Industry Software Inc., Plano, TX (US)

(72) Inventors: Howard Mattson, Cambridge (GB); Douglas King, Cambridge (GB); Mike Gibbens, Cambridge (GB)

(21) Appl. No.: 18/836,936

(22) PCT Filed: Feb. 25, 2022
(86) PCT No.: PCT/US2022/017837

§ 371 Date: Aug. 8, 2024

(51) Int. Cl. G06F 30/12; G06F 111/02; G06F 111/04

(52) U.S. Cl. CPC G06F 30/12; G06F 2111/02; G06F 2111/04

(57) ABSTRACT

A computer-implemented method includes editing, at a local client device, an engineering design (e.g., computer aided design (CAD) model), hosted on a remote server. The local client device and the remote server communicate over a communications network and are remote from each other. The remote server configures an operation within a CAD model based on user input during an edit of the CAD model involving a drag. This results in a subset of the CAD model and the solving instructions required to perform the user update being generated and sent as a data package including the subset of the CAD model and the solving instructions to the local client device. The CAD model and any associated algorithms stored on the remote server are not communicated to the local client device.

The present patent document is a § 371 nationalization of PCT Application Serial No. PCT/US2022/017837, filed Feb. 25, 2022, designating the United States, which is incorporated by reference in its entirety.

### TECHNICAL FIELD

The present disclosure relates to a method and system of editing an engineering design or computer-aided design (CAD) model hosted on a remote server.

### BACKGROUND

As part of creating an engineering design using a Computer-Aided Design (CAD) system, (e.g., a CAD model), a user undertakes many different design actions, including sketch modelling. For this, the desktop standard for interactive performance is particularly high as users expect smooth, accurate and highly interactive dragging of geometry. In locally hosted systems, such as where CAD modelling software is hosted on a desktop device, as the user begins to drag a geometry, algorithms perform an analysis of the CAD model and the drag. Desirable relationships indicating design intent are discovered and maintained during the drag. In addition to the discovered relationships, preferences are set to give predictable and intuitive behavior to the drag. However, as users begin to adopt cloud-based CAD solutions the CAD system and data are no longer exclusively hosted on the user's desktop device. In such cloud computing environments, the technological and data security requirements may be very different to those associated with software installed on a desktop device. Regardless of this, however, users still expect the same performance and behavior of cloud-based CAD systems as they are used to with desktop-based CAD systems.

FIG. 1 is a schematic illustration of a client device and a cloud server forming a CAD system. The client device 10 is a computing resource local to the CAD user. This may be a standalone application or an application running within a web browser, for example. The cloud server 11 is a resource that is remote from the CAD user and may be a distributed computer system, for example. Both the cloud server 11 and the client device 10 communicate with each other via a network 12, with each being provided with a communications interface device to enable the communication to take place. The cloud server 11 holds the definition of the CAD system and the CAD data. The CAD data and algorithms remain on the cloud server 11 and are not shared with the client device 10, providing the security of the CAD system by design. While the provider of the CAD system may have control of the cloud server resources, it does not control and may be unable to determine the capacity of the client device or communications network.

FIG. 2 is a flow chart illustrating a process flow for editing a CAD model. At act 200 of the method, user input is received, which may be via a mouse movement, track pad or other user input device.

At act 202, the CAD system will configure solve and update the model based on the user input.

At act 204, the CAD system produces updated graphical data, and at act 206 a graphic display at the user is updated with the result of the user input. Hence, when the user drags geometry (such as a part in an engineering design), the CAD system is repeatedly updating the displayed graphics to give the user feedback on what is changing within the design. Each of the acts in FIG. 2 are executed for this to happen, which for multiple edits means that the acts are executed repeatedly in an editing loop. The user input within the drag, such as a mouse position or a projection, is used as the parameter for solving the operation and updating the accurate geometry of the CAD model. Once the CAD model is updated the graphical data may be produced. The graphical display may only be updated once the new graphical data has been produced. Once the graphical display has been updated, the next user input may be processed. Obviously, smooth, accurate and highly interactive dragging may only be achieved if this editing loop is iterated at a fast, consistent speed. Progressing around the editing loop slowly results in a poor interactive experience for the user. Smooth dragging is only achieved if the speed at which the editing loop is executed is consistent.

FIG. 3 is a schematic illustration of the flow chart acts of FIG. 2 taking place in a cloud server-local client device system. The left-hand side of FIG. 3 represents the actions taking place at the local client device and the right-hand side represents the actions taking place at the cloud server. User input at act 200 is made at the client device 30. This is transmitted to the cloud server 31, where the cloud server 31 carries out act 202 to configure, solve, and update the CAD model for the user. The cloud server 31 then produces the updated graphical data of act 204 and transmits this back to the client device 30 to update the display at the user with this graphical data at act 206. The loop is repeated for every increment of the drag operation, and has to be done at a fast, consistent speed for the user to experience a smooth, accurate and highly interactive dragging operation. The communication between the local client device 30 and the cloud server 31 is slower than when all of the functions of the CAD system are co-located within a desktop CAD system, with the iteration time determined by the bandwidth, latency, and signal quality constraints of available communications networks. This results in a recognition that a user is not able to experience the same dragging behavior using a cloud-based CAD system than with a desktop-based CAD system.

One example of a solution proposed to overcome these issues is to have sophisticated algorithms for solving and updating the CAD model implemented at the local client device 30. This allows the user to experience a smooth, highly interactive view of the movement, which is also fully accurate in solving and updating a version of the CAD model, which is held locally in the local client device 30. However, one limitation of this approach is that proprietary CAD algorithms for changing the CAD model are transmitted from the cloud server 31 to the local client device 30, compromising data security during transmission. This risk is increased if a web-browser is used. The security of proprietary data may therefore be dependent upon third-party data security provisions over which a user has no control, for example, end-to-end encryption. In addition to the proprietary algorithms, the CAD model data itself is also transmitted across a communications network, which for product development risks the disclosure of new or innovative features or product design to third parties.

Another example of a solution attempting to overcome these issues is for the local client device 30 to calculate and display an approximation of the drag result for intermediate drag positions. The final drag position is performed as an accurate operation by the cloud server 31. This approach initially provides the user with what appears to be a smooth, interactive dragging process. The algorithm used by the local client device 30 is less complex than that used by the cloud server 31, and therefore increases the security of the edit process as there is no transmission of algorithm data across the communications network. A simplified version of the CAD model is retained by the local client device 30 for the approximation method, meaning that the more valuable exact CAD model data may remain on the cloud server 31. However, whilst security concerns may be partly dealt with, a disadvantage of this approach is that when the final accurate cloud server 31 solution to the dragging operation replaces the local client device 30 version there are inevitable differences between the approximated solution and this final version. This is caused by the reduced complexity and increased simplicity of the local client device 30 algorithm and CAD model compared with the exact configuration and solving that takes place on the CAD model version hosted by the cloud server 31. This leads to the editing process ultimately being challenging and frustrating to the user. In addition, because the accurate CAD model data remains on the cloud server 31, the approximation approach is unable to supply accurate updated geometry during a dragging operation. This is a severe limitation for engineering product design. Without accurate geometry, a user is prevented from predicting the exact nature and impact of changes made, for example by realizing following the cloud server 31 solution that components that appear to be adjacent to each other in the local approximation actually overlap. This causes lost time from work being redone or being inadvertently left in an invalid state in the CAD model.

There is therefore a need for a solution that increases the security of the local client device-cloud server CAD model system without compromising on the interactive nature of the editing process perceived by the user.

### SUMMARY

The scope of the present disclosure is defined solely by the appended claims and is not affected to any degree by the statements within this summary. The present embodiments may obviate one or more of the drawbacks or limitations in the related art.

The present disclosure aims to address these issues by providing, in a first aspect, a computer-implemented method of editing, at a local client device, an engineering design (CAD model), hosted on a remote server, wherein the local client device and the remote server communicate over a communications network. The method includes, at the local client device: a) communicating, from the local client device to a remote server, an edit including first user input from a user input device and taking place on a display device at the local client device. The method further includes, at the remote server: b) configuring an operation within a CAD model based on the user input resulting in a subset of the CAD model and the solving instructions required to perform the user update being generated and sending a data package including the subset of the CAD model and the solving instructions to the local client device. The method further includes, at the local client device: c) receiving the data package; d) solving and updating the subset of the CAD model based on the solving instructions and generating updated graphical data from the solved and updated subset of the CAD model; e) updating the display device at the local client device using the updated graphical data; f) receiving at least a second user input within the edit at the local client device; and g) repeating acts d) and e) for each of the at least second user inputs. In this method, the edit includes a plurality of inputs, and all solves within the edit are performed at the local client device without further reference to the remote server.

Providing a data package containing a subset of the CAD model stored on the remote server with the solving instructions allows for a reduced code accurate solving engine hosted on the local client device, rather than either an approximation of a CAD model hosted on the local client device or the transmission of proprietary data and algorithms over a communications network of uncontrolled security.

The subset of the CAD model may be bespoke to the edit.

The act of configuring an operation within a CAD model at the remote server may include the remote server analyzing the edit to form a system of constraints and preferences. Further, the act of defining the subset of the CAD model and solving instructions may include the remote server combining the constraints and preferences that are active in performing the update. In certain examples, the data package may include the subset of the CAD model and driving constraints.

The act of solving and updating the subset of the CAD model at the local client device may include constructing a local instance of the subset of the CAD model as a reduced code solving engine.

The edit may be a dynamic edit. The dynamic edit may be a geometry drag. The edit may be one of a series of edits where the remote server configures an anticipated operation based on previous edits. Alternatively, the edit may be a valued constraint drag.

The remote server may be a distributed computing device. In certain examples, the remote service may be a cloud server. In certain examples, the remote server and the local client device may communicate via a communications network.

The CAD model and any associated algorithms stored on the server may not be communicated to the local client device.

In a second aspect, a Computer-Aided Design (CAD) system is configured to edit an engineering design (CAD model) hosted on a remote server. The CAD system includes: a remote server and a local client device. The remote server of the CAD system includes: a processor adapted to configure an operation within a CAD model based on a user input resulting in a subset of the CAD model and the solving instructions required to perform a user update; a memory associated with the processor and configured to store the CAD model, including solving and configuring algorithms; and a communications interface device configured to send a data package including the subset of the CAD model and the solving instructions over a communications network to the local client device. The local client device of the CAD system includes: a user input device configured to receive an edit including first user input and at least a second user input within the edit; a display device configured to display the edit including first user input taking place on the display device and to display updated graphical data to a user; a communications interface device configured to communicate the edit to the remote server and to receive the data package from the remote server; a processor configured to solve and update the subset of the CAD model based on the solving instructions and generate updated graphical data from the solved and update subset of the CAD model and to repeat for at least a second user input; and a memory associated with the processor and configured to store the subset of the CAD model. The edit includes a plurality of inputs, and all solves within the edit are performed at the local client device without further reference to the remote server.

The CAD model and any associated algorithms stored on the remote server may not be communicated to the local client device.

### BRIEF DESCRIPTION OF THE DRAWINGS

The present disclosure is now described by way of example only, and with reference to the accompanying drawings, in which:

FIG. 1 is a schematic illustration of an example of a client device and a cloud server forming a CAD system.

FIG. 2 is a flow chart illustrating an example of a process flow for editing a CAD model.

FIG. 3 is a schematic illustration of an example of the flow chart acts of FIG. 2 taking place in a cloud server-local client device system.

FIG. 4 is a schematic flowchart showing an example of the acts of a method in accordance with embodiments at both the local client device and the remote server for editing a CAD model.

FIG. 5 is a sketch, in two dimensions, of examples of first and second objects to be edited.

FIG. 6 is a sketch, in two dimensions, of examples of the first and second objects shown in FIG. 5 after an edit by a user.

FIG. 7 illustrates an example of what would happen in an approximation approach, where there is no reduced data solving engine at the local client device.

FIG. 8 is a schematic illustration of a computer-aided design (CAD) system in accordance with an embodiment.

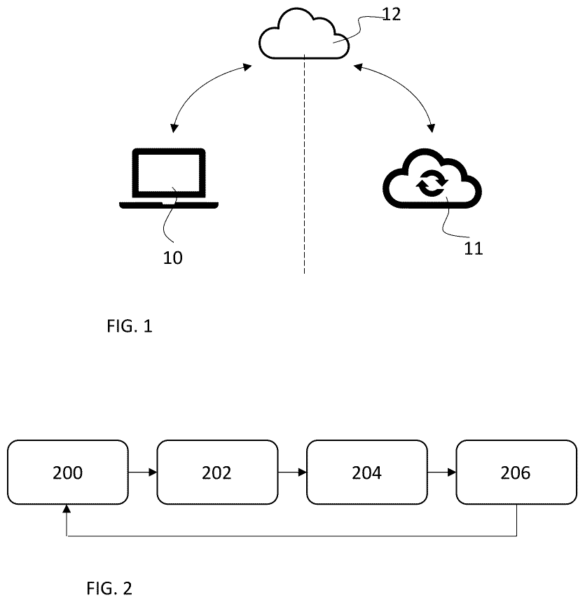

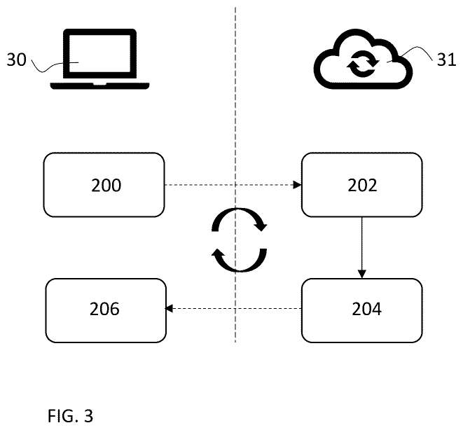

### DETAILED DESCRIPTION

The embodiments of the present disclosure described below benefit from the use of a reduced code solving engine hosted on a local client device, rather than either an approximation of a CAD model hosted on the local client device or the transmission of proprietary data and algorithms over a communications network of uncontrolled security. The embodiments describe a computer implemented method of editing, at a local client device, an engineering design (CAD model), hosted on a remote server, wherein the local client device and the remote server communicate over a communications network. The remote server may be a distributed computing device, such as a cloud server. Initially, at a local client device an edit including first user input from a user input device and taking place on a display device at the local client device is communicated from the local client device to the remote server. Next, at the remote server, an operation is configured within a CAD model based on the user input. This results in in a subset of the CAD model and the solving instructions required to perform the user update being generated. A data package including the subset of the CAD model and the solving instructions are then sent to the local client device. The data package is received at the local client device, where the subset of the CAD model is solved and updated based on the solving instructions. Updated graphical data is generated from the solved and updated subset of the CAD model, which is used to update the display device at the local client device. Because this is an iterative process during a drag of a geometry or valued constraint, such as distance, at least a second user input within the edit is received at the local client device. The solving and updating acts are repeated at the local user device for at least the second user inputs. The edit includes a plurality of inputs, and all solves within the edit are performed at the local client device without further reference to the remote server. This creates a smooth, accurate, and highly interactive editing experience for the user.

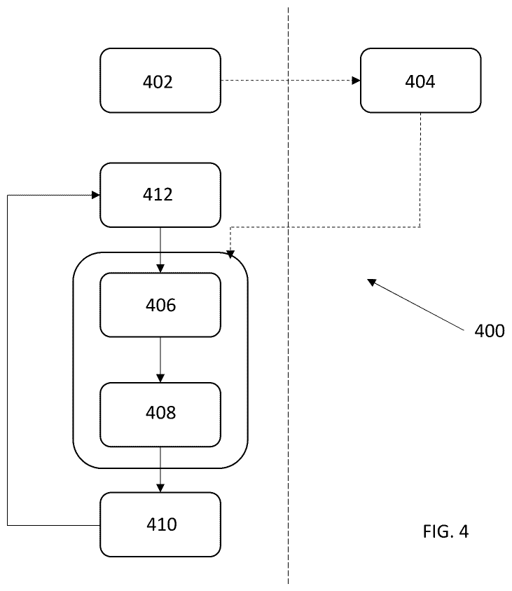

FIG. 4 is a schematic flowchart showing the acts of a method in accordance with embodiments at both the local client device and the remote server for editing a CAD model. The method 400 is split into acts taking place at the local client device (on the left-hand side of the flowchart) and acts taking place at the remote server (on the right-hand side of the flowchart). The remote server and the local client device communicate via a communications network. This may be a Wi-Fi network, such as a local area network (LAN) or wide area network (WAN), or a cellular network.

At act 402, a user will initiate an edit. This includes, at the local client device, communicating, from the local client device to a remote server, an edit including first user input from a user input device and taking place on a display device at the local client device. The edit may be a dynamic edit, (e.g., a geometry drag), where a shape or an element of a shape, (e.g., a face, edge, or vertex), is dragged across the screen of a display device by the user. Alternatively, the edit may be a valued constraint drag, where a valued constraint is a constraint, (e.g., a distance, length, or size), having a value associated with it that may be increased or decreased by dragging part of a shape or element of a shape associated with the valued constraint. For example, the length of an edge may be increased or decreased, or the spacing between shapes may be changed.

Act 404 takes place at the remote server. Here, an operation within a CAD model is configured based on the user input. This results in a subset of the CAD model and the solving instructions required to perform the user update being generated. A data package including the subset of the CAD model and the solving instructions to the local client device. The configuring an operation within the CAD model at the remote server includes the remote server analyzing the edit to form a system of constraints and preferences. Defining the subset of the CAD model and solving instructions includes the remote server combining the constraints and preferences that are active in performing the update. The data package includes the subset of the CAD model and driving constraints, and the subset of the CAD model is bespoke to the edit. In other words, the subset of the CAD model is created for the specific edit that the user is making, rather than an approximation to any edit that the user wishes to make.

At act 406, the method 400 moves back to the local client device, where the data package is received.

At act 408, the local client device solves and updates the subset of the CAD model based on the solving instructions and generates updated graphical data from the solved and updated subset of the CAD model. This includes constructing a local instance of the subset of the CAD model as a reduced code solving engine. Such a reduced code solving engine does not require the same amount of code as the full CAD model hosted on the remote server, nor are the complex algorithms used by the remote server to configure the operations required by the user in the subset of the CAD model required at the local client device.

At act 410, the display device at the local client device is updated using the updated graphical data. This shows the user the first act in the drag operation.

At act 412, at least a second user input is received within the edit at the local client device. This then begins a loop repeating acts 406 and 408 for each of the at least second user inputs. As the display device is updated using the updated graphical data following each of the user inputs in the edit, the user experiences a smooth, accurate and highly interactive dragging operation. This is because although the edit executed by the user includes a plurality of inputs, all solves within the edit are performed at the local client device without further reference to the remote server. The remote server may also configure an anticipated operation based on previous edits made by the user.

The local client device is able to solve the required instructions for each user input during the drag effectively on-the-fly with the correct behavior and the updates the portion of the CAD model that it holds accurately without any further dependence on the remote server. The edit at the local client device is therefore independent of the remote server once the data package is received. The user experiences a smooth, accurate and highly interactive drag as part of the editing process. For each act, the local client device produces accurate CAD model geometry that matches the result that the remote server solves and update algorithms would obtain. This therefore meets the two criteria that prior solutions have failed to address, firstly removing the need for constant local client device and remote server communication, which may be over an unsecured communications network, and secondly, doing so without using an approximation of the edit that does not match a final remote server solve and update because the local client device edits are consistent with those of the remote server. Both entire user CAD model data and proprietary algorithms remain on the remote server, with no need to transfer these to the local client device. This reduces the exposure of valuable data to possible third-party attack during use, with minimal data being transferred outside of the remote server. Because only the data required for the edit is transferred to the local client device (this creates the bespoke element of the method 400, as described above), all other CAD model data remains secure.

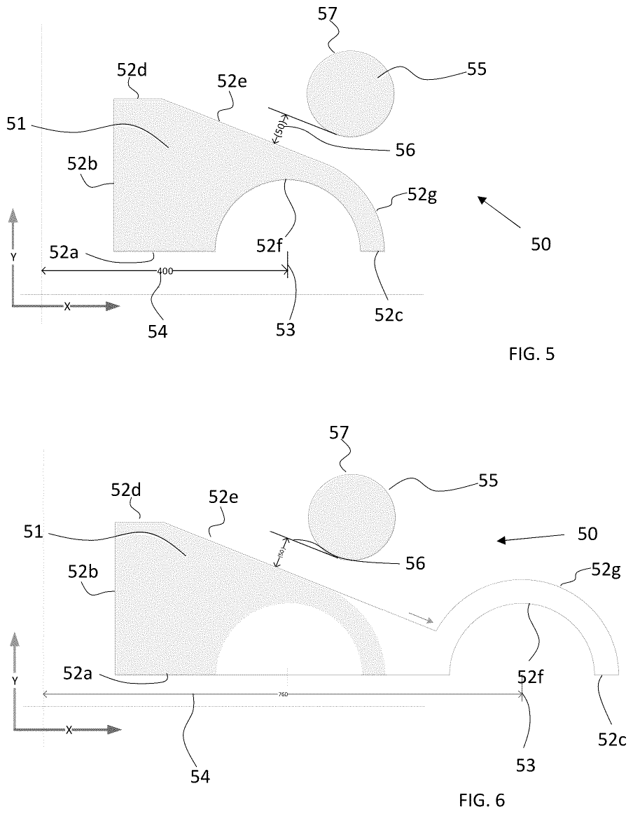

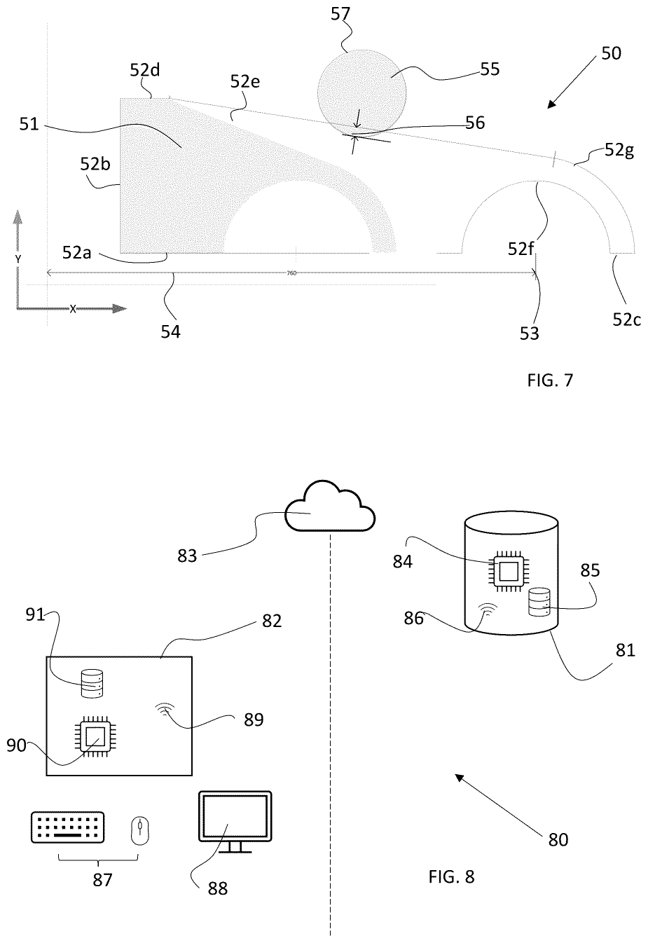

The method 400 is illustrated in further detail in the example embodiment below. FIG. 5 is a sketch, in two dimensions, of first and second objects to be edited. The sketch 50 is set out in two dimensions, with a horizontal x-axis and a vertical y-axis. A first object 51 is complex shape having five linear edges 52a-52e and two circular edges 52f, 52g. The center 53 of the first circular edge 52f is located at a distance of 400 length units along the x-axis from a fixed y-axis line and forms a first dimension 54. A second object 55 is positioned adjacent the first object 51, at a distance of 50 length units forming a second dimension 56. The second object 55 is circular in shape, having a circular edge 57. A user wishes to edit the sketch, as shown in FIG. 7.

FIG. 7 is a sketch, in two dimensions of the first and second objects shown in FIG. 5 after an edit by a user. The user performs a dimension edit by increasing the value of the first dimension 54 from 400 length units to 760 length units. This is to move the center 53 of the first circular edge 52f along the x-axis in a positive direction. This causes the length of the linear edge 52e to be increased to compensate for the increase in the first dimension 54. The second object 55 is not part of the edit and remains in its original position as shown in FIG. 5. The concentricity of the circular edge 52g and the circular edge 52f is maintained, as well as the tangency between the second circular edge 52g and the linear edge 52e of the first object 51.

FIG. 6 illustrates what would happen in an approximation approach, where there is no reduced data solving engine at the local client device. Here, the approximation algorithm at the local client device has maintained the concentricity of the circular edge 52g and the circular edge 52f is maintained, but not the tangency between the second circular edge 52g and the linear edge 52e of the first object 51. The angle of the linear edge 52e remains unchanged during the edit, as does the value of the second dimension 56. Once the edit is committed and the remote server applies the exact algorithm to solve and update the CAD model correctly the clearance violation between the circular edge 57 of the second object 55 and the linear edge 52e is revealed. This is because the algorithm used by the remote server also maintains the tangency between the circular edge 52g and the linear edge 52e by rotating the linear edge 52e. Unless this is reworked by the user, an unnoticed error is introduced into the final engineering product resulting from the CAD model.

FIG. 8 is a schematic illustration of a computer-aided design (CAD) system in accordance with an embodiment. The CAD system 80 includes a remote server 81 and a local client device 82, each adapted to communicate over a communications network 83. The remote server 81 includes a processor 84 adapted to configure an operation within a CAD model based on a user input resulting in a subset of the CAD model and the solving instructions required to perform a user update. A memory 85 is associated with the processor and adapted to store the CAD model, including solving and configuring algorithms. The processor 84 is provided with a communications interface device 86 configured to send the data package including the subset of the CAD model and the solving instructions over the communications network 83 to the local client device 82. The CAD model data and algorithms may be stored in the memory of a single remote server 81 as illustrated or may be split with the CAD model residing on a first remote server in a distributed computing system and the algorithms residing on a second remote server in a distributed computing system. However, in this situation only one of the first and second remote servers will communicate with the local client device 82.

The local client device 82 includes a user input device 87 adapted to receive an edit including first user input and at least a second user input within the edit. A display device 88 is also provided and adapted to display the edit including first user input taking place on the display device and to display updated graphical data to a user. The local client device 82 is also provided with a communications interface device 89 adapted to communicate the edit to the remove server and to receive the data package from the remote server 81. A processor 90 is used in the local client device 82 and is adapted to solve and update the subset of the CAD model based on the solving instructions and generate updated graphical data from the solved and update subset of the CAD model and to repeat for at least a second user input. A memory 91 is associated with the processor and adapted to store the subset of the CAD model. The edit, as outlined above, includes a plurality of inputs, and wherein all solves within the edit are performed at the local client device 82 without further reference to the remote server 81. The CAD model and any associated algorithms stored on the remote server 81 are not communicated to the local client device 82.

The user input device 87 at the local client device 82 may be a keyboard and mouse, or other pointing device, which allows the user to provide input to the local client device 82. Other peripheral devices enabling user input may include one or more I/O controllers such as USB controllers, Bluetooth controllers, and/or dedicated audio controllers (connected to speakers and/or microphones). Various peripherals may be connected to the local client device 82 by a USB controller (via various USB ports) including input devices (e.g., keyboard, mouse, touch screen, trackball, camera, microphone, scanners), output devices (e.g., printers, speakers), or any other type of device that is operative to provide inputs or receive outputs from the local client device 82. Further, devices referred to as input devices or output devices may both provide inputs and receive outputs of communications with the local client device 82. Further, other peripheral hardware connected via I/O controllers may include any type of device, machine, or component that is configured to communicate with the local client device 82. The display device 88 may be any suitable type of graphical display, including a monitor.

An operating system is included in the local client device 82 to enable an output from the local client device 82 to be displayed to the user on the display device 88 and the user to interact with the local client device 82. Examples of operating systems that may be used in a data processing system may include Microsoft Windows™, Linux™, UNIX™, iOS™, and Android™ operating systems.

In addition, the remote server 81 may be implemented in a networked environment, distributed system environment, as virtual machines in a virtual machine architecture, and/or cloud environment. For example, the processor 84 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the local client device 82 may vary for particular implementations. For example, the local client device 82 may correspond to a computer, workstation, or a mobile device such as a tablet computer. The depicted example is provided for the purpose of explanation only and is not meant to imply architectural limitations with respect to the present disclosure. In each of the examples above the communications interface may be a wireless interface or a wired interface. For example, if a user has a tablet or other mobile computing device as the local client device, this is most likely to be provided with a wireless communications interface. However, if the user is using a desktop computer as the local client device this is more likely to be provided with a wired communications interface.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of editing an engineering design, the method comprising:
communicating, from a local client device to a remote server over a communications network, an edit comprising first user input from a user input device and taking place on a display device at the local client device;
configuring, at the remote server, an operation within a computer-aided design (CAD) model based on the first user input resulting in a subset of the CAD model and solving instructions required to perform a user update being generated and sending a data package comprising the subset of the CAD model and the solving instructions to the local client device;
receiving the data package at the local client device;
solving and updating, at the local client device, the subset of the CAD model based on the solving instructions and generating updated graphical data from the solved and updated subset of the CAD model;
updating the display device at the local client device using the updated graphical data;
receiving at least a second user input within the edit at the local client device; and
repeating the solving and updating of the subset and the updating of the display device for each second user input,
wherein the edit comprises a plurality of inputs, and
wherein all solves within the edit are performed at the local client device without further reference to the remote server.

2. The method of claim 1, wherein the subset of the CAD model is bespoke to the edit.

3. The method of claim 1, wherein the configuring of the operation within the CAD model at the remote server comprises the remote server analyzing the edit to form a system of constraints and preferences, and
wherein the updating and solving of the subset of the CAD model and the solving instructions comprise the remote server combining the constraints and preferences that are active in performing the update.

4. The method of claim 3, wherein the data package comprises the subset of the CAD model and driving constraints.

5. The method of claim 1, wherein the step of solving and updating the subset of the CAD model at the local client device comprises constructing a local instance of the subset of the CAD model as a reduced code solving engine.

6. The method of claim 1, wherein the edit is a dynamic edit.

7. The method of claim 6, wherein the dynamic edit is a geometry drag.

8. The method of claim 6, wherein the edit is one edit of a series of edits, and
wherein the remote server configures an anticipated operation based on previous edits.

9. The method of claim 6, wherein the edit is a valued constraint drag.

10. The method of claim 1, wherein the remote server is a distributed computing device.

11. The method of claim 1, wherein the remote server is a cloud server.

12. The method of claim 1, wherein the CAD model and any associated algorithms stored on the remote server are not communicated to the local client device.

13. A Computer-Aided Design (CAD) system adapted configured to edit an engineering design (CAD model), the CAD system comprising:
a remote server comprising:
a processor adapted to configure an operation within the CAD model based on a user input resulting in a subset of the CAD model and solving instructions required to perform a user update;
a memory associated with the processor and configured to store the CAD model, including solving and configuring algorithms; and
a communications interface device configured to send a data package comprising the subset of the CAD model and the solving instructions over a communications network to a local client device; and
the local client device comprising:
a user input device configured to receive an edit comprising a first user input and at least a second user input within the edit;
a display device configured to display the edit comprising the first user input taking place on the display device and to display updated graphical data to a user;
a communications interface device configured to communicate the edit to the remote server and to receive the data package from the remote server;
a processor configured to solve and update the subset of the CAD model based on the solving instructions and generate updated graphical data from the solved and update subset of the CAD model and to repeat for the at least second user input; and
a memory associated with the processor and configured to store the subset of the CAD model,
wherein the edit comprises a plurality of inputs, and
wherein all solves within the edit are performed at the local client device without further reference to the remote server.

14. The CAD system of claim 13, wherein the CAD model and any associated algorithms stored on the remote server are not configured to be communicated to the local client device.

15. The method of claim 7, wherein the edit is one edit of a series of edits, and
wherein the remote server configures an anticipated operation based on previous edits.
